(19) United States
(12) Patent Application Publication
(10) Pub. No.: US 2026/0347032 A1
(43) Pub. Date: Nov. 5, 2026

(54) METHOD OF AND SYSTEM FOR SEALING A PRESSURE CANNER

(71) Applicant: National Presto Industries, Inc., Eau Claire, WI (US)

(72) Inventor: Julian Warwick, Jim Falls, WI (US)

(21) Appl. No.: 19/197,026

(22) Filed: May 2, 2025

(51) Int. Cl. B65B 55/02; A23B 2/00; A23B 2/10; A23B 2/30

(52) U.S. Cl. CPC B65B 55/027; A23B 2/001; A23B 2/10; A23B 2/30

(57) ABSTRACT

Disclosed is a method of sealing a pressure canner using a sealing ring that is independent of the pressure canner lid or body. The method can include a flexible seal mounted on a rigid ring that holds the sealing ring in a circular shape. The sealing ring is placed on a rim portion of a canning vessel and the lid of the pressure canner is affixed to the vessel by aligning a plurality of tabs and slots and rotating the lid relative to the canning vessel. In certain embodiments, the sealing ring is formed from a Y shaped seal where the rigid ring is located at an intersection of a first and second leg of the Y shape.

### CROSS REFERENCE TO RELATED APPLICATIONS

This nonprovisional patent application makes no claim of priority.

### TECHNICAL FIELD

The present invention relates generally to (a system for and method of) sealing a pressure canner to prevent the loss of pressure from an interface between a vessel and the lid portion of the canner.

### BACKGROUND

Canning is a process of preserving foodstuffs in containers. In home canning (residential) environments, the containers are typically glass jars with metal lids. In the canning process, foodstuffs are preserved by sterilizing the contents of the jar and removing oxygen from the foodstuffs and the jar. The metal lid seals the jar as part of the process. In home environments, the canning process is generally facilitated through a device referred to as a “canner.” Canners may be stovetop canners, where the heat source is a stovetop. In addition to stovetop canners, certain canning appliances may include heaters such that a source of electrical power is applied to the canner, whereby the canning appliance produces levels of heat sufficient to perform the canning process.

Traditionally, two types of canning methods exist: water bath canning and pressure canning. Water bath canning is a relatively lower-temperature canning process typically used for high-acid foods, including such foodstuffs as fruits and fruit juices, jams, jellies, salsas, tomato sauces, pickled foods, vinegars, and condiments. The high acidity of the foodstuffs assists in killing bacteria and microorganisms; thus, lower temperatures may be safely used. Pressure canning is performed at a relatively higher temperature (240 °F) and pressure and is used for low-acid foods; examples include vegetables, meats, poultry, and seafood. The higher temperatures employed by the pressure canning process kill any bacteria and microorganisms present in the foodstuffs being canned. As such, achieving and maintaining temperatures high enough to ensure that the bacteria and microorganisms are killed is paramount.

Pressure canners generally comprise a vessel and a lid. In operation, pressure canners are filled with cans containing the foodstuffs to be sterilized, and a small amount of water is added. Once the lid has been fixedly attached to the vessel, the vessel is placed on a heat source such as, for example, a stove top, wherein the heat source is adjusted to an output level sufficient to achieve the high temperatures required. As the vessel is heated, the water inside the vessel begins to boil. The water turns to steam, and because a lid is attached to the vessel, the pressure within the vessel starts to rise. As the pressure increases, the boiling point of the water in the vessel also rises; in this manner, pressure is used to achieve temperatures higher than in an open atmosphere. Pressure canners are thus able to achieve temperatures higher than the ordinary boiling point of water. In order to regulate the temperature of the boiling water and steam, pressure canners are adapted to achieve and maintain a pressure corresponding to a desired water temperature. In order to maintain a desired pressure (and temperature), the pressure canner lid can include a mechanical pressure relief, for example, a weighted rocker or spring-based relief valve, that begins to release pressure/steam above a desired pressure setpoint. It is this relief of pressure that indicates to a user that the appropriate temperature and pressure have been achieved for sterilization. Once achieved, the temperature is maintained for a period of time sufficient to sterilize the foodstuffs, jars, and lids.

Pressure canners typically maintain a pressure of 5 -15 pounds per square inch. The required pressure is directly related to the temperature desired and the atmospheric pressure found at the canning location. While the lid to vessel connection can be formed without a gasket material, doing so can be difficult. Because of this difficulty, pressure canners often utilize a flexible gasket material located between the vessel and the lid. Known pressure canners frequently utilize a gasket that is retained by a flange formed in the lid. This flange allows a user to position the lid on the chamber without worrying about the gasket's placement. However, the gasket can become damaged or contaminated should one of the canning jars leak during the canning process. What is needed is a system and method for positioning a gasket between the vessel and lid while allowing the gasket to be easily examined and cleaned.

### SUMMARY

Embodiments relate to canners, and particularly pressure canners that utilize a vessel, a lid, and a seal between the vessel and the lid to prevent pressure loss during the canning process. More specifically, embodiments comprise a seal that is easily inspected and resists deformation during the process of closing the canner and performing the canning process.

In an exemplary embodiment, a canner is sealed by assembling a sealing ring assembly by inserting a support ring into a recess formed by a first leg of a seal and a second leg of the seal such that the seal is held in a circular shape by the support ring where the support ring is independent of other components of the canner. A sealing ring is placed at a rim of a vessel portion of the canner such that the first leg portion of the seal rests on the rim and a lid assembly is placed in contact with a second leg portion of sealing ring assembly such that the sealing ring assembly is captured between the vessel portion and the lid assembly and the lid assembly is secured to the vessel portion.

In another exemplary embodiment, a device for canning foodstuffs comprises a vessel portion, a lid portion, and a sealing ring assembly comprised of a seal and a rigid support ring. The sealing ring has an outer diameter greater than the inner diameter of the vessel portion and an inner diameter less than the vessel portion's inner diameter. The seal has a cross-sectional area that comprises a first leg, a second leg, and a third leg, one end of each leg connected to the remaining legs to form an intersection, the third leg extending radially from the intersection. The rigid support ring is independent of the vessel and lid portions and is located at the junction of the first and second legs.

In yet another exemplary embodiment, a method of sealing a canner comprises placing a sealing ring on the rim of a vessel. In such an embodiment, the sealing ring comprises a flexible seal having a first leg portion, a second leg portion, and a third leg portion. The sealing ring is held in a circular shape by a support ring, where the sealing ring is not secured to any portion of the canner prior to such placement. The method further comprises placing a lid assembly such that it contacts the sealing ring and covers an opening of the vessel portion, orienting the lid assembly such that a plurality of slots formed in the lid assembly engage a plurality of tabs formed in the vessel portion, and rotating the lid assembly relative to the vessel portion to secure the lid assembly to the vessel portion such that the third leg of the sealing ring is captured between the rim of the vessel and the lid portion.

The above summary is not intended to describe each illustrated embodiment or every implementation of the invention. Rather, the exemplary embodiments are chosen and described so as to provide an overview or framework for understanding the nature and character of the claimed aspects and implementations so that those skilled in the art can appreciate and understand the principles and practices of the invention. The Figures and the detailed description that follow more particularly exemplify these exemplary embodiments, and are incorporated in and constitute a part of this specification.

### BRIEF DESCRIPTION OF THE DRAWINGS

These and other features and advantages of the present invention will become better understood with regard to the following description and accompanying drawings, in which:

FIG. 1 is a front perspective view of an electric canner including an exemplary embodiment of a sealing ring;

FIG. 2 is a front perspective view of an electric canner shown in an exploded arrangement, including a sealing ring according to an exemplary embodiment;

FIG. 3 is a partial cross-section view of an electric canner including a sealing ring according to an exemplary embodiment;

FIG. 4 is a flow diagram showing the steps of using a sealing ring according to an exemplary embodiment; and

FIG. 5 is a cross-sectional view of a sealing ring according to an alternate embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

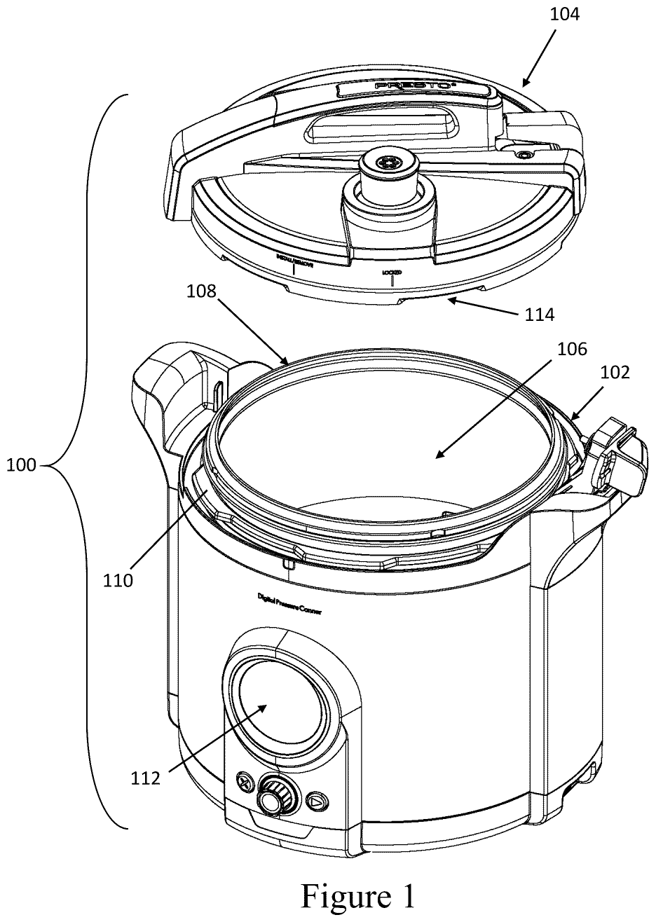

Illustrated in FIG. 1 is an electric canner 100 comprising an exemplary embodiment of a sealing ring assembly 108. As illustrated, the electric canner 100 comprises a base assembly 102, a vessel portion 106 positioned in the base assembly 103, and a lid assembly 104. Also shown is a control portion 112 containing electrical controls, such as temperature controllers and timers, that control the electronic portions of the electric canner 100. When using an exemplary electric canner, a user adds foodstuffs contained in canning jars into the vessel portion 106, adds an amount of water that partially covers the canning jars, positions the sealing ring assembly 108 at an upper edge of the vessel portion 106, and places the lid assembly 104 on the vessel portion such that the sealing ring assembly 108 is positioned between the vessel portion 106 and the lid assembly 104. The user then secures the lid assembly 104 to the base assembly 102 using any of a plurality of methods of fixing the lid assembly 104 to the base assembly 102. In the illustrated embodiment, the base assembly 102 comprises a plurality of tabs 110 that engage with slots 114 formed in the lid assembly 104 and secure the lid assembly 104 to the base assembly 102 when the lid assembly 104 is partially rotated relative to the base assembly 102. After securing the lid, heat is applied to the vessel portion 106 such that the water in the vessel portion 106 turns to steam. In exemplary embodiments, this is controlled by the control portion 112. Should the connection between the vessel portion 106 and the lid assembly 104 allow pressure to escape from the vessel portion 106, the pressure may not achieve levels sufficient to allow temperatures high enough to sterilize the contents of the vessel portion 106 and thus, fail to properly preserve the foodstuffs found in the canning jars. In an exemplary embodiment, the sealing ring assembly 108 serves to prevent the steam from escaping from a gap between the lid assembly 104 and the vessel portion 106. In this manner, the pressure inside the vessel portion 106 increases. The result is that the boiling point of the water is raised, allowing the temperature inside the vessel portion 106 to rise above the unpressurized boiling point of water such that the foodstuffs inside the canning jars can be reliably sterilized during the canning process.

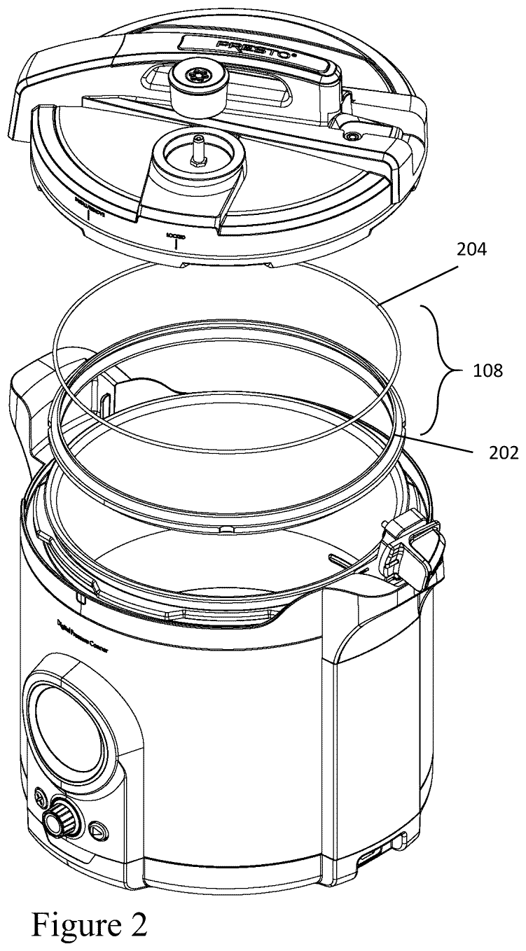

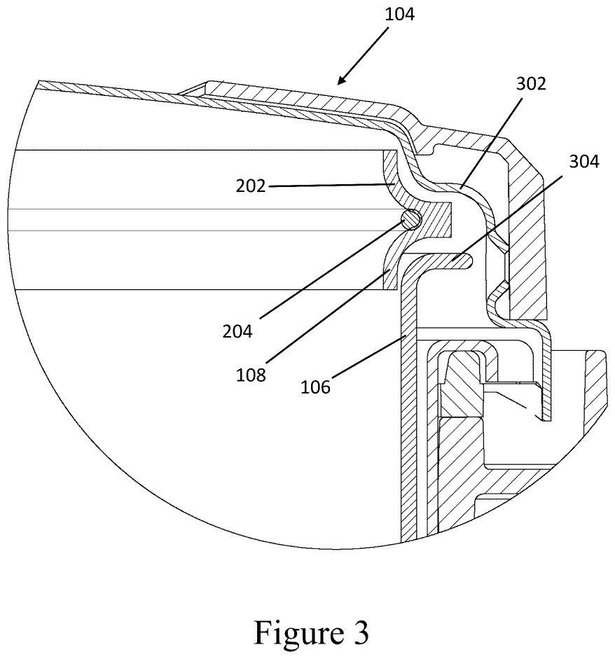

FIG. 2 illustrates the electric canner of FIG. 1 with the addition of showing the sealing ring assembly 108 separated into its components. An exemplary sealing ring assembly 108 comprises a seal 202 and a support ring 204. FIG. 3 illustrates a cross-sectional view of the sealing ring assembly 108 in position between a rim 304 of the vessel portion 106 and an inner portion 302 of the lid assembly 104. As was noted above, the ring assembly comprises a seal 202. In order to conform to variations in the rim 304 and inner portion 302, the seal 202 must be able to flex to make contact with minor imperfections in the rim 304 and inner portion 302. However, the flexibility of the seal 202 could allow it to be pushed or jostled such that the seal 202 moves away from the rim 304 and inner portion 302, and thus does not fill the space between the inner portion 302 of the lid assembly 104 and the rim 304. As shown in FIG. 3, a support ring 204 is positioned such that it holds the seal 202 in position between the rim 304 and the inner lid portion 302 of the electric canner 100. As illustrated, the seal 202 of the exemplary embodiment is formed in a “V” shape such that the legs of the V shape can flex to make contact with the rim 304 and inner portion 302 while the support ring 204 is positioned at the base of the V shape where the legs meet. This configuration holds the base of the V shape in the gap between the rim 304 and inner portion 302 of the lid assembly 104. The fact that the sealing ring assembly 108 is independent of the lid assembly 104 and the vessel portion 106 permits the sealing ring assembly 108 to be easily cleaned compared to a traditional seal captured by a flange formed in the lid. In addition to easy cleaning, the independence of the sealing ring assembly allows a user to easily inspect the seal 202 and to ensure that it is correctly positioned on the rim 304 and not deformed or twisted.

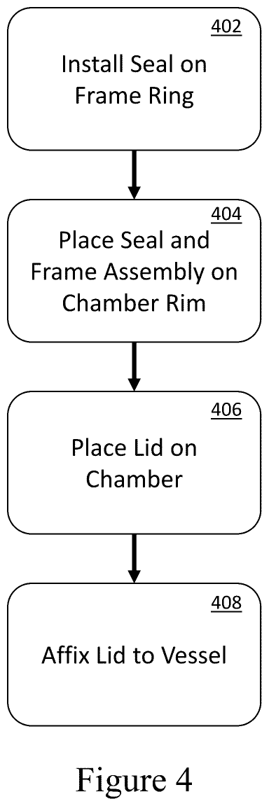

As illustrated in FIG. 4, in step 402, a user installs the seal 202 onto the support ring 204. This step may start with the seal 202 and the support ring 204 separated, as shown in FIG. 2. In this step, a user inserts the support ring 204 into a groove formed in the seal 202 to provide a level of rigidity sufficient to prevent the seal assembly 108 from being dislodged from its place between the lid assembly 104 and the vessel 106. In step 404, the user places the seal assembly 108 atop the vessel 106 such that it is supported in that position. In step 406, the lid assembly 104 is placed on the vessel portion 106. As was previously noted, the rigidity of the support ring 204 prevents the sealing ring assembly 108 from being displaced by the lid assembly 104. In step 408, the lid assembly is affixed to the vessel portion 106. This may be performed by rotating the lid assembly 104 such that tabs 110 formed on the base assembly 102 engage with slots 114 formed in the lid assembly, such that the lid assembly 104 is held tightly against the base assembly 102, capturing the sealing ring assembly between the lid assembly 104 and base assembly 102. After the lid assembly 104 is affixed to the base assembly 102 and a seal is formed between the vessel portion 106 and the lid assembly 104, the canning process can proceed with minimal risk that the sealing ring assembly 108 will leak.

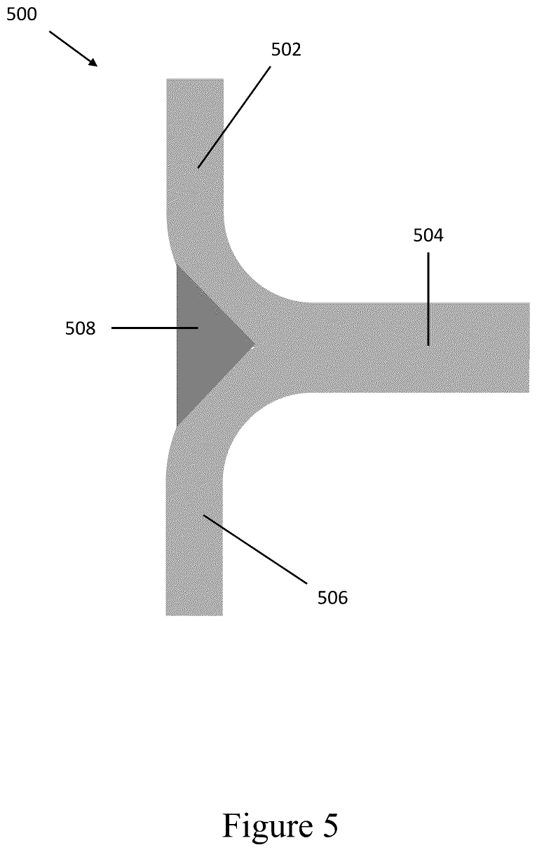

FIG. 5 illustrates an alternate embodiment of a sealing ring. As illustrated, the sealing ring 500 comprises a first leg 502, a second leg 504, and a third leg 506 configured in a manner similar to the embodiment illustrated in FIG. 3. However, in this embodiment, the sealing ring 500 comprises a stiffener 508 instead of a support ring to hold the sealing ring 500 in a circular shape necessary to ensure that the first, second, and third legs (502, 504, and 506) contact the vessel and lid assembly to form a seal. The illustrated embodiment uses a stiffener portion 508 which is formed from a material that is flexible enough that the sealing ring 500 can be compressed into an oval shape for shipping or storage, but sufficiently rigid to urge the sealing ring into a circular shape to enable the first, second, and third legs (502, 504, and 506) contact the vessel and lid assembly to form a seal. This arrangement provides the necessary flexibility in the leg portions to ensure a seal with rigidity in the central portion of the sealing ring 500 to maintain a circular shape. In exemplary embodiments, the stiffener may be secured to the leg portions of the sealing ring with an adhesive or, more optimally, be molded into the leg portions during a manufacturing process.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc., have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

Any implementation or embodiment disclosed herein can be combined with any other implementation or embodiment. References to “an implementation,” “some implementations,” “one implementation,” “an embodiment,” “some embodiments,” “certain embodiments,” or the like are not necessarily mutually exclusive. They are intended to indicate that a particular feature, structure, or characteristic described in connection with the implementation can be included in at least one implementation or embodiment. Such terms as used herein do not necessarily refer to the same implementation. Any implementation or embodiment can be combined with any other implementation or embodiment, inclusively or exclusively, in any manner consistent with the aspects and implementations disclosed herein.

Where technical features in the drawings, detailed description or any claim are followed by reference numbers, the reference numbers have been included to increase the intelligibility of the drawings, detailed description, and claims. Accordingly, neither the reference numbers nor their absence have any limiting effect on the scope of any claim elements.

Coupled elements can be electrically, magnetically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the Figures. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

What is claimed is:

1. A method of sealing a canner comprising the steps of:
assembling a sealing ring assembly by inserting a support ring into a recess formed by a first leg of a seal and a second leg of the seal such that the seal is held in a circular shape by the support ring where the support ring is independent of other components of the canner;
placing the sealing ring assembly at a rim of a vessel portion of the canner such that the first leg portion of the seal rests on the rim;
placing a lid assembly in contact with a second leg portion of sealing ring assembly such that the sealing ring assembly is captured between the vessel portion and the lid assembly; and
securing the lid assembly to the vessel portion.

2. The method of claim 1, further comprising the step of moving the lid assembly such that portions of the lid assembly come into contact with the vessel portion of the canner.

3. The method of claim 2, where securing the lid assembly to the vessel portion comprises the steps of:
engaging a tab of the vessel portion with a slot of the lid assembly; and
rotating the lid assembly relative to the vessel portion.

4. The method of claim 1, where the cross-sectional area of the seal resembles the letter Y.

5. The method of claim 4, where the intersection of the first leg portion and the second leg portion includes a curve with a radius that is the same as a cross-sectional radius of the support ring.

6. The method of claim 1, where the seal is formed of a flexible material.

7. The method of claim 1, wherein the support ring is formed from a flexible material and is inserted during a manufacturing process.

8. The method of claim 1, wherein the support ring is formed from a rigid material.

9. The method of claim 8, wherein the rigid material is metallic.

10. A device for canning foodstuffs that comprises:
a vessel portion;
a lid portion;
a sealing ring assembly comprised of a seal and a support ring, the sealing ring having an outer diameter that is greater than an inner diameter of the vessel portion and an inner diameter that is less than the inner diameter of the vessel portion, the seal having a cross sectional area that comprises a first leg, a second leg, and a third leg, one end of each leg connected to the remaining legs to form an intersection, the third leg extending radially from the intersection, the support ring independent of the vessel portion and the lid portion and located at the intersection of the first and second legs.

11. The device of claim 10, where the third leg portion of the sealing ring contacts both the vessel portion and the lid portion.

12. The device of claim 10, wherein the seal portion of the sealing ring is formed from a flexible material.

13. The device of claim 10, wherein the support ring is formed from a flexible material.

14. The device of claim 10, wherein the support ring is formed from a metalic material.

15. The device of claim 10, where the vessel portion comprises a plurality of tabs and the lid portion comprises a plurality of slots adapted to receive the plurality of tabs.

16. The device of claim 15, where the plurality of tabs and slots secure the lid portion to the vessel portion, the sealing ring assembly being captured between a rim of a vessel portion and an inner portion of the lid assembly.

17. A method of sealing a canner comprising the steps of:
placing a sealing ring on a rim of a vessel, the sealing ring comprising a flexible seal, the flexible seal having a first leg portion, a second leg portion, and a third leg portion, the sealing ring held in a circular shape by a support ring where the sealing ring is not secured to any portion of the canner prior to such placement;
placing a lid assembly such that it contacts the sealing ring and covers an opening of the vessel portion;
orienting the lid assembly such that a plurality of slots formed in the lid assembly engage a plurality of tabs formed in the vessel portion; and
rotating the lid assembly relative to the vessel portion to secure the lid assembly to the vessel portion such that the third leg of the sealing ring is captured between the rim of the vessel and the lid portion.
